(19) United States
(12) Patent Application Publication
(10) Pub. No.: US 2026/0050545 A1
(43) Pub. Date: Feb. 19, 2026

(54) VOLATILE MEMORY DEVICE, MEMORY CONTROLLER AND MEMORY SYSTEM

(71) Applicant: Samsung Electronics Co., Ltd., Suwon-si (KR)

(72) Inventors: Doo Won Bong, Sowon-si (KR); Woo II Kim, Suwon-si (KR); Ha On Jang, Suwon-si (KR); Hyun Bo Kim, Suwon-si (KR); In Su Choi, Suwon-si (KR); Seok-Chan Hong, Suwon-si (KR)

(73) Assignee: Samsung Electronics Co., Ltd., Suwon-si (KR)

(21) Appl. No.: 19/078,830

(22) Filed: Mar. 13, 2025

(30) Foreign Application Priority Data
Aug. 19, 2024 (KR) 10-2024-0110651

(51) Int. Cl. G06F 12/02

(52) U.S. Cl. CPC G06F 12/0223

(57) ABSTRACT

A volatile memory device, memory controller, and memory system are provided. A memory device comprises a memory cell array including a first space and a second space, a control logic circuit configured to control an operation of the memory cell array, wherein the control logic circuit is configured to, in response to receiving a first read control command targeting the first space, read, from first model data stored at a first start address in the first space to second model data stored at a first end address in the first space, in sequential order by address, and the control logic circuit is configured to, in response to receiving a second read control command targeting second data stored in the second space, read the second data in non-sequential order by address.

### CROSS-REFERENCE TO RELATED APPLICATIONS

This present application claims priority to and the benefit under 35 U.S.C. §119(a)-(d) of Korean Patent Application No. 10-2024-0110651 filed on Aug. 19, 2024, in the Korean Intellectual Property Office, the entire disclosure of which is incorporated herein by reference.

### BACKGROUND

The present disclosure relates to a volatile memory device, a memory controller and a memory system.

With the development of technologies such as artificial intelligence (AI), big data and edge computing, demands to process a larger amount of data in devices more quickly are emerging. In other words, applications that perform complex computation need faster data processing.

In addition, due to the enlargement of a generative AI model, considerable resources and time are required for learning or inference of the artificial intelligence model. In the process, a vast amount of data are exchanged between a host device such as CPU and GPU and a memory. Therefore, research is being conducted to improve read or write performance of the memory in user experience related to the generative AI model.

### SUMMARY

An object of the present disclosure is to provide a memory device having improved read performance.

Another object of the present disclosure is to provide a memory controller capable of improving read performance of a memory device.

Other object of the present disclosure is to provide a memory system having improved read performance.

According to some embodiments of the present disclosure, there is provided a volatile memory device that comprises a memory cell array including a first space and a second space, a control logic circuit configured to control an operation of the memory cell array, wherein the control logic circuit is configured to, in response to receiving a first read control command targeting model data stored in the first space, read the model data, from first model data stored at a first start address in the first space to second model data stored at a first end address in the first space in sequential order by address, and, in response to receiving a second read control command targeting second data stored in the second space, read the second data in non-sequential order by address from the second space.

According to some embodiments of the present disclosure, there is provided a memory controller that comprises a processing circuit configured to control an operation of a volatile memory device, the volatile memory device including a first space allocated to storing first model data set and a second space allocated to storing second data, and a clock generator configured to provide, to the volatile memory device, a clock signal for the operation of the volatile memory device, wherein the clock generator is configured to generate a first data clock signal having a first frequency and a second data clock signal having a second frequency lower than the first frequency, wherein the processing circuit is configured to, in response to receiving a first read command targeting the first model data set, provide the volatile memory device with: a first turbo read control command instructing the volatile memory device to read the first model data set in sequential order by address, the first data clock signal, a first start address that is a first address of the first model data set, and a first end address that is a last address of the first model data set, t, and wherein the processing circuit is configured to, in response to receiving a second read command targeting the second data, provide the volatile memory device with: a second read control command instructing the volatile memory device to read the second data in non-sequential order by address, the second data clock signal, and an address of the second data.

According to some embodiments of the present disclosure, there is provided a memory system that comprises a memory cell array including a first space and a second space, a volatile memory device including a control logic circuit configured to control the memory cell array, and a memory controller including a processing circuit configured to control an operation of the volatile memory device, and the memory controller further including a clock generator configured to provide the volatile memory device with a clock signal for the operation of the volatile memory device, wherein the clock generator is configured to generate a first data clock signal having a first frequency and a second data clock signal having a second frequency lower than the first frequency, wherein the control logic circuit is configured to, in response to receiving a first read control command targeting the first space, read at least some of a plurality of model data, stored in the first space, in sequential order by address based on the first data clock signal, and wherein the control logic circuit is configured to, in response to receiving a second read control command targeting second data stored in the second space, read the second data in non-sequential order by address based on the second data clock signal.

The objects of the present disclosure are not limited to those mentioned above and additional objects of the present disclosure, which are not mentioned herein, will be clearly understood by those skilled in the art from the following description of the present disclosure.

### BRIEF DESCRIPTION OF THE DRAWINGS

FIG. 1 is a block diagram illustrating a memory system.

FIG. 2 is a block diagram illustrating the memory device of FIG. 1.

FIG. 3 is a block diagram illustrating the memory cell array of FIG. 2.

FIG. 4 is a block diagram illustrating the first artificial neural network model space of FIG. 3.

FIG. 5 is a block diagram illustrating the normal space of FIG. 3.

FIG. 6 is a flow chart illustrating a process of reading normal data stored in a first space.

FIG. 7 is a flow chart illustrating a process of reading model data stored in a second space.

FIG. 8 is a detailed flow chart illustrating a process of reading the plurality of model data of FIG. 7.

FIG. 9 is a flow chart illustrating a process of writing model data by allocating a third space.

FIG. 10 is a block diagram illustrating the third space of FIG. 9.

FIG. 11 is a block diagram illustrating the memory controller of FIG. 1.

FIG. 12 is a block diagram illustrating a process of reading normal data stored in a normal space.

FIG. 13 is a block diagram illustrating a process of reading a first model data set stored in a first artificial neural network model space.

FIG. 14 is a block diagram illustrating a memory system.

FIG. 15 is a view illustrating a memory module.

FIG. 16 is a view illustrating a semiconductor package.

FIG. 17 is a view illustrating an implementation example of a semiconductor package.

FIG. 18 is a view illustrating a semiconductor package.

### DETAILED DESCRIPTION

Hereinafter, the embodiments according to the technical spirits of the present disclosure will be described with reference to the accompanying drawings.

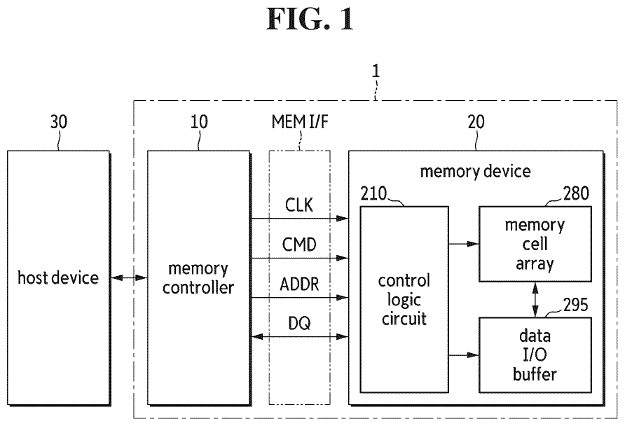

FIG. 1 is a block diagram illustrating a memory system.

Referring to FIG. 1, the memory system may include a host device 30 and a memory storage device 1. The memory storage device 1 may include a memory device 20 and a memory controller 10.

The memory controller 10 may control an overall operation of the memory device 20. For example, the memory controller 10 may control data exchange between the external host device 30 and the memory device 20. For example, the memory controller 10 may control the memory device 20 in accordance with a request of the host device 30, thereby writing or reading data.

The memory controller 10 and the memory device 20 may perform communication with each other through a memory interface MEM I/F. Also, the memory controller 10 and the external host device 30 may perform communication with each other through a host interface. That is, the memory controller 10 may relay signals between the memory device 20 and the host device 30. The memory controller 10 may control the operation of the memory device 20 by applying a command CMD for controlling the memory device 20. In this case, the memory device 20 may include dynamic memory cells. For example, the memory device 20 may include a Dynamic Random Access Memory (DRAM), Double Data Rate 4 (DDR4), a Synchronous DRAM (SDRAM), a Low Power DDR4 (LPDDR4) SDRAM, or LPDDR5 SDRAM, but the embodiments according to the technical spirits of the present disclosure are not limited thereto. The memory device 20 may include a non-volatile memory device. However, in the present embodiment, the memory device 20 will be described as a volatile memory device.

The memory controller 10 may transmit a clock signal CLK, a command CMD, an address ADDR signal, etc. to the memory device 20. The memory controller 10 may provide data DQ to the memory device 20, and may receive the data DQ from the memory device 20. The memory device 20 may include a memory cell array 200 for storing the data DQ, a control logic circuit 210 and a data input/output buffer 295.

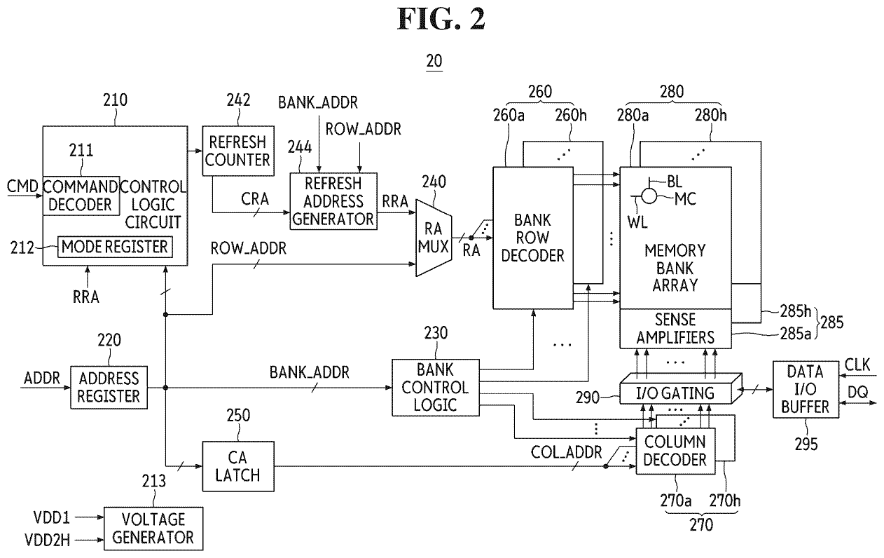

FIG. 2 is a block diagram illustrating the memory device of FIG. 1.

Referring to FIG. 2, the memory device 20 may include a control logic circuit 210, a voltage generator 213, an address register 220, a bank control logic circuit 230, a row address multiplexer 240, a refresh counter 242, a refresh address generator 244, a column address latch 250, a row decoder 260, a column decoder 270, a memory cell array 280, a sense amplifier 285, an input/output gating circuit 290, and a data input/output buffer 295.

The memory cell array 280 may include a plurality of memory bank arrays 280a to 280h. Although FIG. 2 shows that the memory cell array 280 include eight memory bank arrays 280a to 280h, the present disclosure is not limited thereto.

Each of the plurality of memory bank arrays 280a to 280h may include a plurality of word lines WL, a plurality of bit lines BL, and a plurality of memory cells MC formed at a point where the word lines WL and the bit lines BL cross each other.

The row address multiplexer 240 may include a plurality of bank row decoders 260a to 260h connected to the plurality of memory bank arrays 280a to 280h, respectively. The column decoder 270 may include a plurality of column decoders 270a to 270h connected to a plurality of memory bank arrays 280a to 280h, respectively. The sense amplifier 285 may include a plurality of sense amplifiers 285a to 285h connected to a plurality of memory bank arrays 280a to 280h, respectively.

The address register 220 may receive an address ADDR, which includes a bank address BANK_ADDR, a row address ROW_ADDR and a column address COL_ADDR, from the memory controller (10 of FIG. 1). The address register 220 may provide the received bank address BANK_ADDR to the bank control logic circuit 230, provide the received row address ROW_ADDR to the row address multiplexer 240 and provide the received column address COL_ADDR to the column address latch 250.

The bank control logic circuit 230 may generate bank control signals in response to the bank address BANK_ADDR. In response to the bank control signals, the bank row decoder, which corresponds to the bank address BANK_ADDR, among the plurality of bank row decoders 260a to 260h may be activated, and the column decoder, which corresponds to the bank address BANK_ADDR, among the plurality of column decoders 270a to 270h may be activated.

The refresh counter 242 may sequentially output counting row addresses CRA under the control of the control logic circuit 210. For example, the control logic circuit 210 may generate a refresh count signal in response to a normal refresh command. The refresh counter 242 may perform a counting operation in response to the refresh count signal, and may output the counting row address CRA. That is, the refresh counter 242 may output a refresh address for performing a normal refresh operation.

The refresh address generator 244 may receive the bank address BANK_ADDR and the row address ROW_ADDR. The refresh address generator 244 may count a value, at which the bank address BANK_ADDR and the row address ROW_ADDR are activated, based on the bank address BANK_ADDR and the row address ROW_ADDR. The refresh address generator 244 may generate a row address corresponding to a word line activated more than a predetermined number of times or a row address corresponding to an adjacent word line of the word line as a hammer address based on the counted value. That is, the refresh address generator 244 may output a refresh address for performing a target row refresh operation.

The refresh address generator 244 may output one of the counting row address CRA and the hammer address as a refresh row address RRA.

The refresh counter 242 and the refresh address generator 244 may be implemented as separate elements as shown, or the refresh counter 242 and the refresh address generator 244 may be implemented as a single element. Also, the refresh counter 242 and the refresh address generator 244 may be implemented to be included in the control logic circuit 210.

The row address multiplexer 240 may receive the row address ROW_ADDR from the address register 220, and may receive the refresh row address RRA from the refresh address generator 244. The row address multiplexer 240 may selectively output the row address ROW_ADDR or the refresh row address RRA as the row address RA. The row address RA output from the row address multiplexer 240 may be applied to each of the plurality of bank row decoders 260a to 260h.

The bank row decoder, which is activated by the bank control logic circuit 230, among the plurality of bank row decoders 260a to 260h may decode the row address RA output from the row address multiplexer 240 to activate a word line corresponding to the row address. For example, the activated bank row decoder may apply a word line driving voltage to the word line corresponding to the row address.

The column address latch 250 may receive the column address COL_ADDR from the address register 220, and may temporarily store the received column address COL_ADDR. The column address latch 250 may gradually increase the column address COL_ADDR received in a burst mode. The column address latch 250 may apply the temporarily stored column address COL_ADDR or the gradually increased column address COL_ADDR to each of the plurality of column decoders 270a to 270h.

The bank column decoder, which is activated by the bank control logic circuit 230, among the plurality of column decoders 270a to 270h, may activate the sense amplifier corresponding to the bank address BANK_ADDR and the column address COL_ADDR through the corresponding input/output gating circuit 290.

The input/output gating circuit 290 may include an input data mask logic, read data latches for storing data output from the plurality of memory bank arrays 280a to 280h, and write drivers for writing data in the plurality of memory bank arrays 280a to 280h, along with circuits for gating input/output data.

The data DQ to be read from one bank array among the plurality of memory bank arrays 280a to 280h may be sensed by a sense amplifier (one of 285a to 285h) corresponding to the one bank array and stored in the read data latches. The data DQ stored in the read data latches may be provided to the memory controller 10 through the data input/output buffer 295.

The data DQ to be written in one of the plurality of memory bank arrays 280a to 280h may be provided to the input/output gating circuit 290, and the input/output gating circuit 290 may write the data in the one bank array through the write drivers.

The control logic circuit 210 may control the operation of the memory device 20. For example, the control logic circuit 210 may generate control signals so that the memory device 20 performs a write operation or a read operation. The control logic circuit 210 may include a command decoder 211 for decoding a command CMD received from the memory controller 10 and a mode register 212 for setting an operation mode of the memory device 20.

According to some embodiments, the memory controller (10 of FIG. 1) may read information stored in the mode register 212 to check whether the memory device 20 supports a Turbo Read Mode (e.g., is configured to read data in sequential order by address and in non-sequential order by address in response to respective read control commands, as described herein).

For example, the command CMD may include an active command for converting the memory cell array 280 to an active state for writing or reading data, a precharge command for converting the memory cell array 280 to a standby state, a refresh command for controlling a refresh operation for the memory cell array 280, and a command for reading the information stored in the mode register 212.

The voltage generator 213 may receive a voltage from an external device (e.g., the memory controller 10 of FIG. 1) or the host device (30 of FIG. 1) to generate various voltages sufficient for the operation of the memory device 20. For example, the voltage generator 213 may receive a first input voltage VDD1 and a second input voltage VDD2H to generate and provide various voltages sufficient for the operation of the control logic circuit 210, the plurality of bank row decoders 260a to 260h and the sense amplifiers 285a to 285h of the memory device 20. However, the voltage generator 213 may further receive input voltages other than the first input voltage VDD1 and the second input voltage VDD2H, and may generate and provide voltages sufficient for other elements in the memory device 20 in addition to the control logic circuit 210, the plurality of bank row decoders 260a to 260h and the sense amplifiers 285a to 285h.

The memory cells MC may be, for example, DRAM memory cells. Each of the memory cells MC may be connected to one word line WL and one bit line BL. The memory cell MC may store charges through a cell capacitor. Since a leakage current occurs in the memory cell MC due to a structure of the memory cell MC, data stored in the cell capacitor may be destroyed.

Therefore, the memory device 20 may perform a refresh operation of recharging data in the memory cell MC to prevent the data stored in the memory cell MC from being changed by a leakage current.

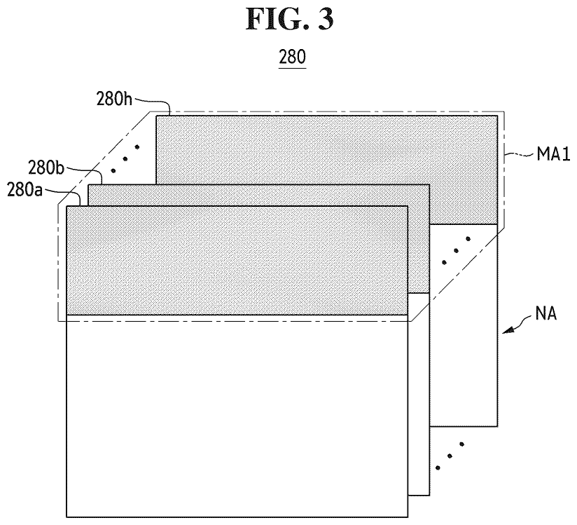

FIG. 3 is a block diagram illustrating the memory cell array of FIG. 2.

Referring to FIG. 3, a partial region of the memory cell array 280 may be allocated to a first artificial neural network model space MA1. The remaining region which is not allocated to the specific space may be a normal space NA. As described above, since the memory cell array 280 may include a plurality of memory bank arrays 280a to 280h, the first artificial neural network model space MA1 may be allocated to a partial region of each of the plurality of memory bank arrays 280a to 280h.

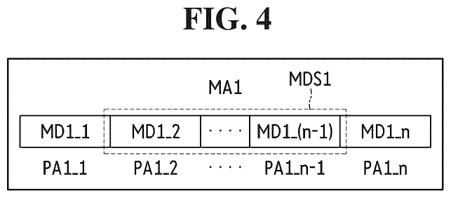

FIG. 4 is a block diagram illustrating the first artificial neural network model space of FIG. 3.

Referring to FIG. 4, a plurality of model data MD1_1 to MD1_n may be stored in the first artificial neural network model space MA1. Each of the plurality of stored model data MD1_1 to MD1_n may have a physical address based on a position stored in the memory cell array 280. For example, among the plurality of model data MD1_1 to MD1_n, the first model data MD1_1 may have a first physical address PA1_1 based on the position stored in the memory cell array 280. Among the plurality of model data MD1_1 to MD1_n, the (n)th model data MD1_n may have an (n)th physical address PA1_n based on the position stored in the memory cell array 280.

A memory interleaving technique is to store data having adjacent addresses in different memory banks, thereby allowing the stored data to be accessed simultaneously. Since the memory interleaving technique is well known to those skilled in the art, its detailed description will be omitted.

According to some embodiments, the plurality of model data MD1_1 to MD1_n stored in the first artificial neural network model space MA1 may be sequentially stored (e.g., in sequentially-ordered addresses) in the first artificial neural network model space MA1 of each of the plurality of memory bank arrays (280a to 280h of FIG. 3) in the order of addresses (e.g., from an address with the smallest address number to an address with the largest address) in accordance with the memory interleaving technique. For example, the plurality of model data MD1_1 to MD1_n may be sequentially stored in the first artificial neural network model space MA1 of each of the plurality of memory bank arrays (280a to 280h of FIG. 3) in the order of addresses from the first model data MD1_1 stored at the first physical address PA1_1 as the first address to the (n)th model data MD1_n stored at the (n)th physical address PA1_n as the last address in accordance with the memory interleaving technique. The first address may be, for example, a physical address having the smallest address number among physical addresses at which the plurality of model data MD1_1 to MD1_n are stored. The last address may be, for example, a physical address having the largest address number among physical addresses at which the plurality of model data MD1_1 to MD1_n are stored.

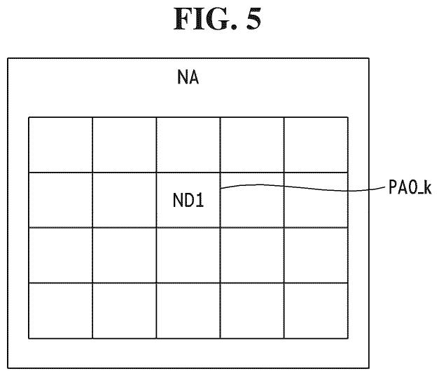

FIG. 5 is a block diagram illustrating the normal space of FIG. 3.

Referring to FIG. 5, normal data ND1 may be stored in the normal space NA. The normal data ND1 may have a first physical address PA0_k based on the position stored in the memory cell array 280. The normal data ND1 may be stored at a non-sequential (e.g., random) position within the memory cell array 280, and the first physical address PA0_k at which the normal data ND1 is stored may be used to access the normal data ND1.

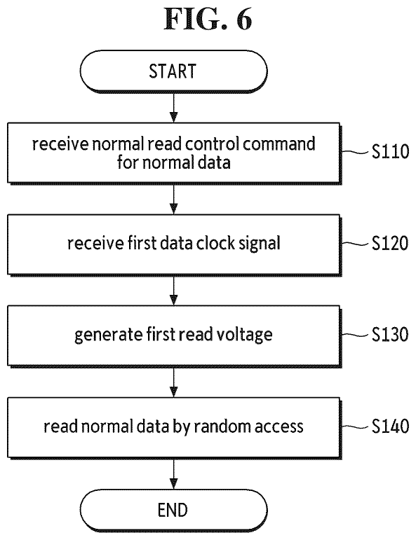

FIG. 6 is a flow chart illustrating a process of reading normal data stored in a first space.

A process of reading normal data stored in a first space will be described with reference to FIGS. 1 to 6.

A normal read control command for normal data is received (S110). For example, the memory device 20 may receive a normal read control command for the normal data ND1 stored in the first space from the memory controller 10 through the command decoder 211. The first space may be a normal space NA, but is not limited thereto.

In order for the memory device 20 to access the normal data ND1 stored in the first space, the memory device 20 needs to know a position in the memory cell array 280, in which the normal data ND1 is stored. That is, in order to access the normal data ND1, the memory device 20 may need information on a physical address at which the normal data ND1 is stored. Therefore, the normal read control command for the normal data ND1 may include information on the physical address PA0_k at which the normal data ND1 is stored.

A first data clock signal is received (S120). For example, the memory device 20 may receive a first data clock signal WCK1, which is a clock signal for reading the normal data ND1, from the memory controller 10.

A first voltage is generated (S130). For example, the voltage generator 213 of the memory device 20 may generate a first read voltage Vri by using the received first input voltage VDD1 and the received second input voltage VDD2H based on the normal read control command received by the control logic circuit 210. The first read voltage Vri may be a voltage used to read the normal data ND1 based on the first data clock signal WCK1.

Normal data is read by non-sequential (e.g., random) access thereto (S140). For example, the control logic circuit 210 of the memory device 20 may read the normal data ND1 stored in the first space (e.g., the normal space NA) of the memory cell array 280 based on the first data clock signal WCK1. The normal data ND1 may be output in the form of a plurality of data pieces DQ equivalent to a preset burst length during the read process. In order to access the normal data ND1, the control logic circuit 210 of the memory device 20 may read the normal data ND1 by non-sequential (e.g., random) access to the normal data ND1 based on information on the physical address PA0_k, at which the normal data ND1 is stored, included in the normal read control command.

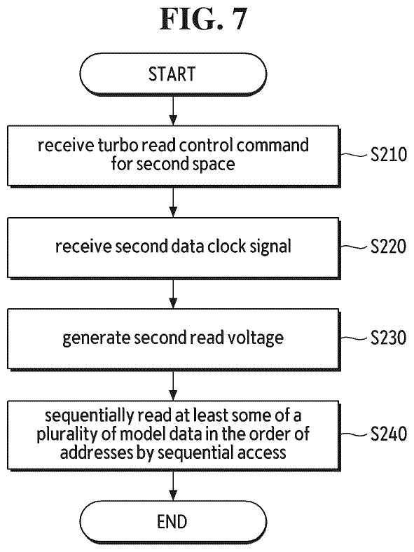

FIG. 7 is a flow chart illustrating a process of reading model data stored in a second space.

Referring to FIGS. 1 to 5 and 7, a turbo read control command for the second space is received (S210). For example, the memory device 20 may receive the turbo read control command from the memory controller 10 through the command decoder 211. The second space may be the artificial neural network model space described above, but is not limited thereto.

According to some embodiments, unlike S110 of FIG. 6, the turbo read control command may not include information on physical addresses PA1_1 to PA1_n respectively corresponding to the plurality of model data MD1_1 to MD1_n stored in the second space (e.g., the first artificial neural network model space MA1). For example, the turbo read control command may include information on the second space (e.g., the first artificial neural network model space MA1) instead of the physical addresses PA1_1 to PA1_n respectively corresponding to the plurality of model data MD1_1 to MD1_n. In this case, the turbo read control command may instruct the memory device 20 to read all data (e.g., the plurality of model data MD1_1 to MD1_n) stored in the second space (e.g., the first artificial neural network model space MA1).

Unlike the above-described example, when a first model data set MDS1 (e.g., MD1_2 to MD_(n−1) which is a portion of the plurality of model data MD1_1 to MD1_n, is to be read, the turbo read control command may include information on a first address (e.g., PA1_2) and information on a last address (e.g., PA1_(n−1)) among physical addresses (e.g., PA1_2 to PA1_(n−1)) corresponding to the first model data set MDS1 to be read. In this case, the turbo read control command may instruct the memory device 20 to read the first model data set MDS1 (e.g., MD1_2 to MD_(n−1)), which is a portion of the plurality of model data MD1_1 to MD1_N stored in the second space (e.g., the first artificial neural network model space MA1).

A second data clock signal is received (S220). For example, the memory device 20 may receive, from the memory controller 10, a second data clock signal WCK2 which is a clock signal for reading at least a portion of the plurality of model data MD1_1 to MD1_n.

According to some embodiments, the second data clock signal WCK2 may have a higher frequency than the first data clock signal WCK1 of S120 of FIG. 6. In general, a maximum bandwidth of the memory device 20 is determined by multiplying a frequency of a data clock signal by a size of a memory bus. Since the frequency of the second data clock signal WCK2 is higher than the frequency of the first data clock signal WCK1, when data is read based on the second data clock signal WCK2, the maximum bandwidth of the memory device 20 is greater than when data is read based on the first data clock signal WCK1. For example, when the memory device 20 reads data based on the second data clock signal WCK2, the maximum bandwidth may be about 10.7 Gbps, and when data is read based on the first data clock signal WCK1, the maximum bandwidth may be about 9.6 Gbps. That is, when data is read based on the second data clock signal WCK2, data may be read faster than when data is read based on the first data clock signal WCK1.

A second read voltage is generated (S230). For example, the voltage generator 213 of the memory device 20 may generate a second read voltage Vᵣ₂ by using the received first input voltage VDD1 and the received second input voltage VDD2H based on the turbo read control command received by the control logic circuit 210. The second read voltage Vᵣ₂ may be a voltage used to read at least a portion of the plurality of model data MD1_1 to MD1_n based on the second data clock signal WCK2.

According to some embodiments, since the second data clock signal WCK2 has a higher frequency than the first data clock signal WCK1 of S120 of FIG. 6, the second read voltage Vᵣ₂ used to read data based on the second data clock signal WCK2 may be higher than the first read voltage Vᵣ₁ used to read data based on the first data clock signal WCK1 of S130 of FIG. 6.

At least some of a plurality of model data are read in sequential order by address (e.g., by sequential access thereto) (S240). For example, the control logic circuit 210 of the memory device 20 may read at least some of the plurality of model data MD1_1 to MD1_n stored in the second space (e.g., the first artificial neural network model space MA1) of the memory cell array 280 based on the second data clock signal WCK2. Each of the plurality of model data MD1_1 to MD1_n may be output in the form of a plurality of data pieces DQ equivalent to a preset burst length during the read process.

According to some embodiments, the turbo read control command may include information on the second space (e.g., the first artificial neural network model space MA1). In this case, the memory device 20 may sequentially access all data (e.g., the plurality of model data MD1_1 to MD1_n) stored in the second space (e.g., the first artificial neural network model space MA1) and read all data stored in the second space (e.g., the first artificial neural network model space MA1) in the order of addresses. For example, in response to receiving the turbo read control command including information on the second space (e.g., the first artificial neural network model space MA1), the memory device 20 may sequentially access the plurality of model data MD1_1 to MD1_n from the first model data MD1_1 corresponding to a first start address PA1_1 as a first address to the (n)th model data MD1_n corresponding to a first end address PA1_n as a last address, and may sequentially read all data stored in the second space (e.g., the first artificial neural network model space MA1) in the order of addresses.

According to some embodiments, the turbo read control command may include information on a first start address (e.g., PA1_2) as a first address and information on a first end address (e.g., PA1_(n−1)) as a last address, among physical addresses (e.g., PA1_2 to PA1_(n−1)) corresponding to the first model data set MDS (e.g., MD1_2 to MD_(n−1)) which is a portion of the plurality of model data MD1_1 to MD1_n. In this case, the memory device 20 may sequentially read the first model data set MDS (e.g., MD1_2 to MD_(n−1)), which is a portion of the plurality of model data (e.g., MD1_1 to MD1_n) in the order of addresses by sequential access from the model data (e.g., MD1_2) corresponding to the first start address (e.g., PA1_1) to the model data (e.g., MD_(n−1)) corresponding to the first end address (e.g., PA1_(n−1)).

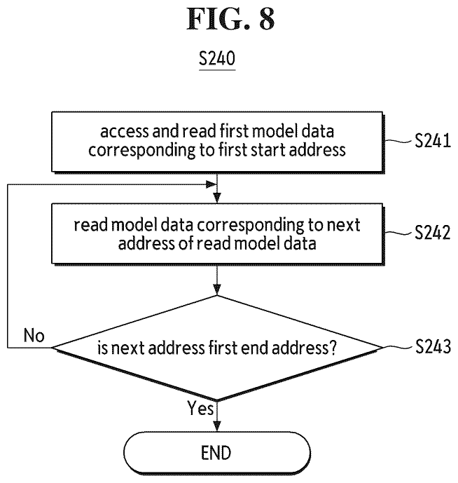

FIG. 8 is a detailed flow chart illustrating a process of reading the plurality of model data of FIG. 7.

Referring to FIG. 8, first model data corresponding to the first start address is accessed and read (S241). According to some embodiments, when the turbo read control command includes information on the second space (e.g., the first artificial neural network model space MA1), the first address of the second space (e.g., the first artificial neural network model space MA1) may be the first start address. In other words, the first address (e.g., PA1_1) among the physical addresses (e.g., PA1_1 to PA1_n) corresponding to all of stored data (e.g., the plurality of model data MD1_1 to MDS1_n) may be the first start address. The read first model data (e.g., MD1_1) may be provided to the memory controller 10.

In addition, according to some embodiments, when the turbo read control command includes information on the first start address (e.g., PA1_2) as the first address and information on the first end address (e.g., PA1_(n−1) as the last address among the physical addresses (e.g., PA1_2 to PA1_(n−1) corresponding to the first model data set MDS (e.g., MD1_2 to MD_(n−1)) which is a portion of the plurality of model data MD1_1 to MD1_n, the received first start address (e.g., PA1_2) may be used as the first start address as it is. The read first model data (e.g., MD1_1) may be provided to the memory controller 10.

Model data corresponding to next address of the read model data is accessed and read (S242). For example, after the first model data (e.g., MD1_1) is read, model data (e.g., MD1_2) corresponding to next address (e.g., PA1_2) of the first model data (e.g., MD1_1) may be accessed and read. The read model data (e.g., MD1_2) may be provided to the memory controller 10.

It is determined whether the next address of the read model data is the first end address (S243). According to some embodiments, for example, when the turbo read control command includes information on the second space (e.g., the first artificial neural network model space MA1), the last address of the second space (e.g., the first artificial neural network model space MA1) may be the first end address.

In addition, according to some embodiments, when the turbo read control command includes information on the first start address (e.g., PA1_2) as the first address and information on the first end address (e.g., PA1_(n−1)) as the last address among the physical addresses (e.g., PA1_2 to PA1_(n−1)) corresponding to the first model data set MDS (e.g., MD1_2 to MD_(n−1)) which is a portion of the plurality of model data MD1_1 to MD1_n, the received first end address (e.g., PA1_(n−1)) may be used as the first end address as it is.

When it is determined that the next address of the read model data is the first end address (S243—Yes), the read operation may be terminated. When it is determined that the next address of the read model data is not the first end address (S243—No), the current step returns to step S242 and the read operation may continue by accessing the model data corresponding to the next address of the read model data.

According to the current trend, mobile communication devices such as smartphones and laptops are internalizing artificial intelligence applications using various artificial intelligence models in devices in the form of on-devices. One of critical factors that determine processing speed in user experience of an on-device application using a large language model (LLM), which is a type of artificial intelligence models, is the average time during which a token (a data unit of a character recognized by LLM) is generated. The generation time of a token generated after a first token is generated is mainly affected by a read bandwidth of a main memory (e.g., dynamic random access memory (DRAM). In other words, when a high read bandwidth may be secured, the user experience for the on-device application using a generative AI model may be greatly improved.

According to some embodiments, the memory device according to the present disclosure may store model data in the artificial neural network model space by allocating the artificial neural network model space separately from the normal space. Afterwards, when the stored model data is read, the model data may be read based on an instantaneously higher data clock signal, whereby an instantaneously higher read bandwidth may be acquired.

According to some embodiments, the memory device according to the present disclosure may read model data based on the data clock signal, which is higher at only a specific status, by receiving a specific command (e.g., the above-described turbo read control command), thereby significantly improving the user experience for the on-device application using the generative AI model while minimizing the increase in power consumption according to the use of the high data clock signal.

According to some embodiments, the memory device according to the present disclosure enables stable overclocking by simultaneously raising internal voltages to make sure of an operating margin of the memory device according to the use of the high data clock signal.

According to some embodiments, the memory device according to the present disclosure writes data in sequentially-ordered addresses and reads the data in sequential order by address in consideration of memory interleaving in the artificial neural network model space, and thus may have optimal read performance.

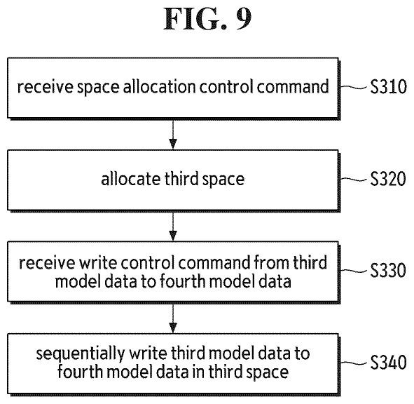

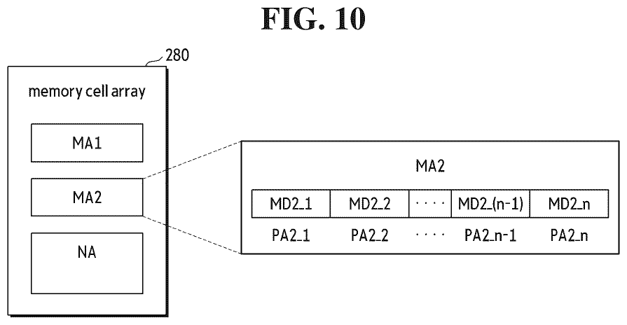

FIG. 9 is a flow chart illustrating a process of writing model data by allocating a third space. FIG. 10 is a block diagram illustrating the third space of FIG. 9.

Referring to FIGS. 9 and 10, a space allocation control command instructing to allocate a space for storing model data is received (S310). For example, the memory device 20 may receive, from the memory controller 10, a space allocation control command instructing to allocate a space for storing a plurality of model data different from the plurality of model data stored in the second space (e.g., the first artificial neural network model space MA1). The third space may be a second artificial neural network model space MA2 different from the first artificial neural network model space MA1 described above, but is not limited thereto.

The third space is allocated to the memory cell array (S320). For example, the memory device 20 may allocate a third model space (e.g., the second artificial neural network model space MA2) to the memory cell array 280 in response to receiving the space allocation control command from the memory controller 10. The third space (e.g., the second artificial neural network model space MA2) may convert a portion of the second space (e.g., the normal space NA) into the third space (e.g., the second artificial neural network model space MA2), but the allocation method is not limited thereto, and the third space (e.g., the second artificial neural network model space MA2) may be allocated in various ways.

A first write control command instructing to write third model data to fourth model data in the third space is received (S330). For example, the memory device 20 may receive the first write control command instructing to write the third model data MD2_1 to the fourth model data MD2_n in the third space (e.g., the second artificial neural network model space MA2) and a plurality of model data including the third model data MD2_1 and the fourth model data MD2_n from the memory controller 10.

The third model data to the fourth model data are written in the third space in sequentially-ordered addresses (S340). For example, the memory device 20 may sequentially write the third model data MD2_1 to the fourth model data MD2_n in the third space (e.g., the second artificial neural network model space MA2) in the order of addresses in accordance with the memory interleaving technique.

The plurality of model data MD2_1 to MD2_n stored in the third space (e.g., the second artificial neural network model space MA2) may be read by the method described above. For example, in response to receiving the turbo read control command for the third space (e.g., the second artificial neural network model space MA2) from the memory controller 10, the memory device 20 may sequentially access and read the fifth model data (e.g., MD2_2) corresponding to a second start address (e.g., PA2_2) to the sixth model data (e.g., MD2_(n−1)) corresponding to a second end address (e.g., MD2_(n−1)) in the order of addresses.

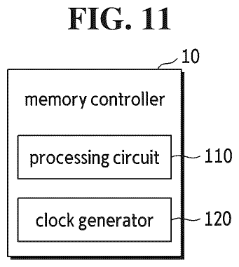

FIG. 11 is a block diagram illustrating the memory controller of FIG. 1.

Referring to FIG. 11, the memory controller 10 may include a processing circuit 110 and a clock generator 120. The processing circuit 110 may control the overall operation of the memory controller 10. For example, the processing circuit 110 may receive a data read command from the host device 30 of FIG. 1 and control the memory device 20 so that the memory device 20 in which the data requested by the host device 30 is stored may read the data requested by the host device 30.

The clock generator 120 may generate various clock signals sufficient for the operation of the memory device 20. The memory device 20 may perform a write or read operation of data based on the clock signal received from the clock generator 120. The higher the frequency of the received clock signal, the faster the write or read operation of data may be. According to some embodiments, the clock generator 120 may generate a first data clock signal WCK1 and a second data clock signal WCK2. The second data clock signal WCK2 may have a higher frequency than the first data clock signal WCK1. The first data clock signal WCK1 may be a reference clock signal when the memory device 20 reads data stored in the normal space. The second data clock signal WCK2 may be a reference clock signal when the memory device 20 reads data stored in the first artificial neural network model space (and the second artificial neural network model space).

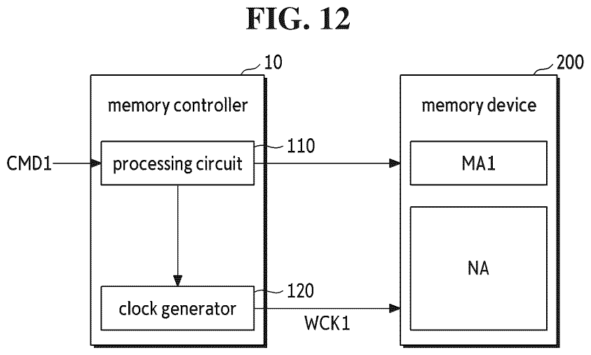

FIG. 12 is a block diagram illustrating a process of reading normal data stored in a normal space.

The memory controller 10 may receive a first read command CMD1 on normal data stored in the normal space from the external device (e.g., the host device 30). The memory controller 10 may provide the first data clock signal WCK1 generated by the clock generator 120 to the memory device 20 in response to the first read command CMD1. The memory controller 10 may provide an address of the normal data to the memory device 20 in response to the first read command CMD1. The address of the normal data may mean a physical address corresponding to normal data stored in the normal space NA of the memory cell array 280. In response to the first read command CMD1, the memory controller 10 may provide the memory device 20 with a normal read control command instructing to read the normal data by non-sequentially (e.g., randomly) accessing the normal data. The memory device 20 may read the normal data by non-sequentially (e.g., randomly) accessing the address of the normal data based on the first data clock signal WCK1 in accordance with the normal read control command. The memory device 20 may provide the read normal data to the memory controller.

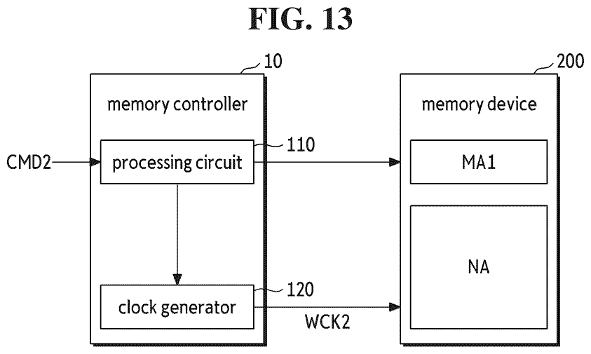

FIG. 13 is a block diagram illustrating a process of reading a first model data set stored in a first artificial neural network model space.

The memory controller 10 may receive a second read command CMD2 for the first model data set among the plurality of model data stored in the first artificial neural network model space from the external device (e.g., the host device 30 of FIG. 1). The memory controller 10 may provide the second data clock signal WCK2 generated by the clock generator 120 to the memory device 20 in response to the second read command CMD2. The memory controller 10 may provide the first start address of the first model data set and the first end address of the first model data set to the memory device 20 in response to the second read command CMD2. The first start address may mean a physical address corresponding to model data having the lowest address number among the first model data set stored in the first artificial neural network model space MA1 of the memory cell array 280. The first end address may mean a physical address corresponding to model data having the largest address number among the first model data set stored in the first artificial neural network model space MA1 of the memory cell array 280. In response to the second read command CMD2, the memory controller 10 may provide the memory device 20 with a turbo read control command instructing to sequentially access and read the first model data set in the order of addresses. The memory device 20 may sequentially access the first start address to the first end address based on the second data clock signal WCK2 in accordance with the turbo read control command to read the first model data set. The memory device 20 may provide the read first model data set to the memory controller 10.

According to some embodiments, the memory controller according to the present disclosure may designate only a specific storage space (e.g., the first artificial neural network model space described above) in the memory device, and may not separately designate an address of each data to be read. Therefore, an address mapping process of converting a system address of data to be read into a physical address of the memory device may be omitted. Accordingly, resources of the memory controller and the host device may be saved.

According to some embodiments, the memory controller according to the present disclosure may designate only a first address and a last address among the plurality of model data to be read, in the memory device. That is, addresses between the first address and the last address among the plurality of model data to be read may not be provided to the memory device. Accordingly, resources of the memory controller and the host device may be saved.

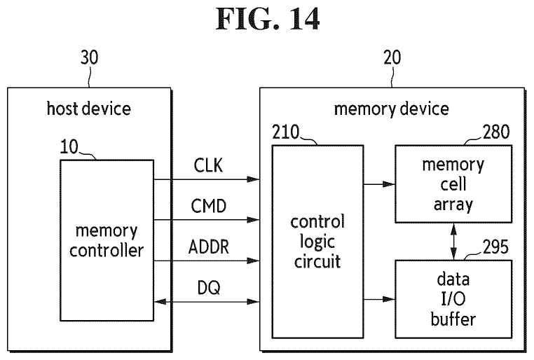

FIG. 14 is a block diagram illustrating a memory system.

Referring to FIG. 14, the host device 30 may include a memory controller 10. That is, in the memory system described with reference to FIG. 1, the memory controller 10 is positioned outside the host device 30, whereas the host device 30 according to the embodiment of the present disclosure may include the memory controller 10. The host device 30 may control the memory device 20 through the memory controller 10. In this case, the host device 30 may perform communication with the memory device 20 based on one of standards such as a double data rate (DDR), a low power double data rate (LPDDR), a graphics double data rate (GDDR), a Wide I/O, a High Bandwidth Memory (HBM), a Hybrid Memory Cube (HMC), or a Compute eXpress Link (CXL).

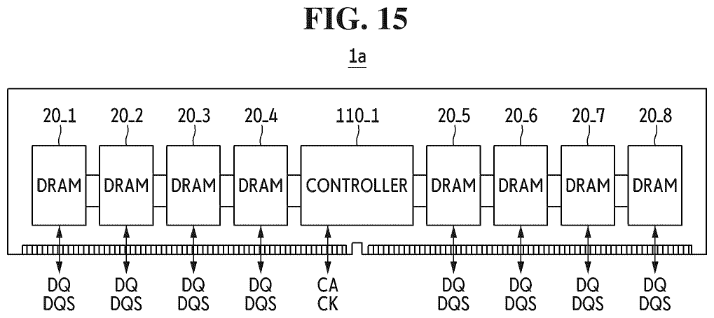

FIG. 15 is a view illustrating a memory module.

Referring to FIG. 15, a memory module 1a may include a controller 110_1 and a plurality of memory devices 20_1 to 20_8. The memory module 1a may be mounted in an electronic device.

The plurality of memory devices 20_1 to 20_8 may correspond to the memory device 20 described above. The controller 110_1 may perform some functions of the memory controller 10 described above.

The host (e.g., the host device 30 of FIG. 1) may control the memory module 1a in accordance with a communication protocol such as a double data rate (DDR) or a low power DDR (LPDDR). For example, in order to read data stored in the memory module 1a, a host (e.g., the host device 30 of FIG. 1) may transmit a command and an address to the memory module 1a.

The plurality of memory devices 20_1 to 20_8 may write data or output written data under the control of a CPU. Each of the plurality of memory devices 20_1 to 20_8 may be at least one of dynamic random access memory (DRAM) or SDRAM.

The plurality of memory devices 20_1 to 20_8 may exchange data DQ in response to a signal provided from the controller 110_1. The plurality of memory devices 20_1 to 20_8 may further include data buffers for data communication, and the data buffers may be synchronized with data strobe signals DQS to exchange data DQ with the host device 30. Unlike the shown example, the plurality of memory devices 20_1 to 20_8 may perform communication the data DQ with the host (e.g., the host device 30 of FIG. 1) via the controller 110_1.

According to some embodiments, the controller 110_1 may perform communication with the memory devices 20_1 to 20_8 in accordance with one of the standards of memory modules such as Dual In-Line Memory Module (DIMM), Registered DIMM (RDIMM), Load Reduced DIMM (LRDIMM), and UDIMM.

The controller 110_1 may receive a command/address CA and a clock signal CK of the memory module la through memory input/output pins, and may provide the received signals to the memory devices 20_1 to 20_8.

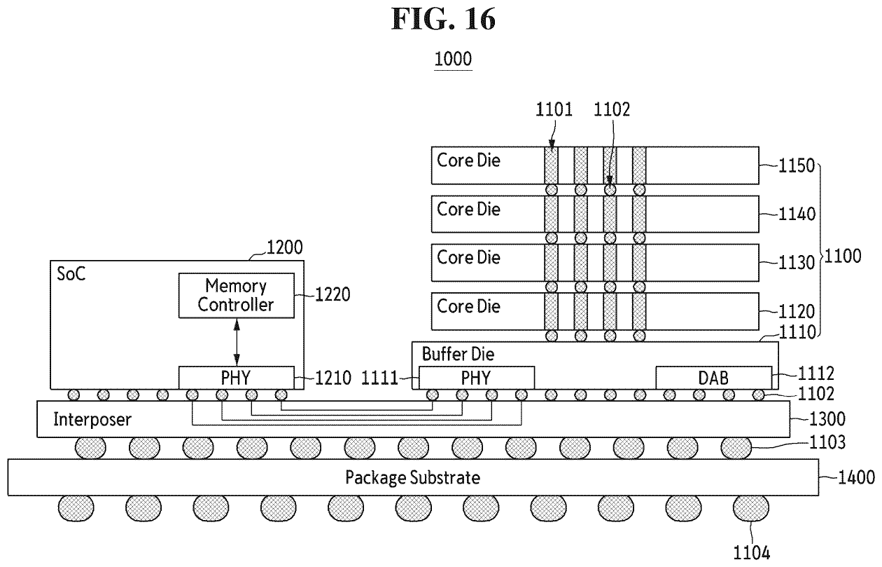

FIG. 16 is a view illustrating a semiconductor package.

Referring to FIG. 16, the semiconductor package may include a stacked memory device 1100, a system-on-chip 1200, an interposer 1300, and a package substrate 1400. The stacked memory device 1100 may include a buffer die 1110 and core dies 1120 to 1150. The core dies 1120 to 1150 may include the memory device 20 described with reference to FIGS. 1 to 15. The buffer die 1110 may include a physical layer 1111 and a direct access region (DAB) 1112. The physical layer 1111 may be electrically connected to a physical layer 1210 of the system-on-chip 1200 through the interposer 1300. The stacked memory device 1100 may receive signals from the system-on-chip 1200 through the physical layer 1111, or may transmit the signals to the system-on-chip 1200.

The direct access region 1112 may provide an access path that may test the stacked memory device 1100 without passing through the system-on-chip 1200. The direct access region 1112 may include a conductive means (e.g., port or pin) that may directly perform communication with an external test device. A test signal and data received through the direct access region 1112 may be transmitted to the core dies 1120 to 1150 through TSVs. Data read from the core dies 1120 to 1150 to test the core dies 1120 to 1150 may be transmitted to the test device through the TSVs and the direct access region 1112. Therefore, a direct access test for the core dies 1120 to 1150 may be performed.

The buffer die 1110 and the core dies 1120 to 1150 may be electrically connected to one another through TSVs 1101 and bumps 1102. The buffer die 1110 may receive signals provided to each channel through the bumps 1102 allocated for each channel from the system-on-chip 1200. For example, the bumps 1102 may be micro-bumps.

The system-on-chip 1200 may execute applications supported by the semiconductor package 1000 by using the stacked memory device 1100. For example, the system-on-chip 1200 may include at least one processor of a central processing unit (CPU), an application processor (AP), a graphic processing unit (GPU), a neural processing unit (NPU), a tensor processing unit (TPU), a vision processing unit (VPU), an image signal processor (ISP), or a digital signal processor (DSP) to execute specialized computations.

The system-on-chip 1200 may include the physical layer 1210 and a memory controller 1220. The physical layer 1210 may include input/output circuits for transmitting and receiving signals to and from the physical layer 1111 of the stacked memory device 1100. The system-on-chip 1200 may provide various signals to the physical layer 1111 through the physical layer 1210. The signals provided to the physical layer 1111 may be transferred to the core dies 1120 to 1150 through the TSVs 1101 and interface circuits of the physical layer 1111.

The memory controller 1220 may control the overall operation of the stacked memory device 1100. The memory controller 1220 may transmit signals for controlling the stacked memory device 1100 to the stacked memory device 1100 through the physical layer 1210. The memory controller 1220 may correspond to the memory controller 10 of FIG. 1.

The interposer 1300 may connect the stacked memory device 1100 with the system-on-chip 1200. The interposer 1300 may connect the physical layer 1111 of the stacked memory device 1100 with the physical layer 1210 of the system-on-chip 1200, and may provide physical paths formed using conductive materials. Therefore, the stacked memory device 1100 and the system-on-chip 1200 may be stacked on the interposer 1300 to transmit and receive signals to and from each other.

Bumps 1103 may be attached to an upper portion of the package substrate 1400, and solder balls 1104 may be attached to a lower portion of the package substrate 1400. For example, the bumps 1103 may be flip-chip bumps. The interposer 1300 may be stacked on the package substrate 1400 through the bumps 1103. The semiconductor package 1000 may transmit and receive signals to and from other external packages or semiconductor devices through the solder balls 1104. For example, the package substrate 1400 may be a printed circuit board (PCB).

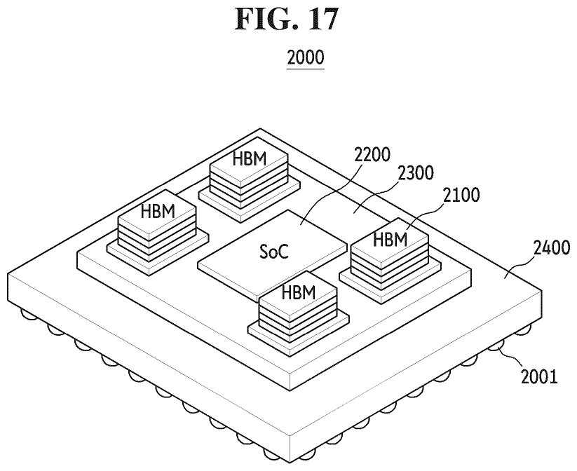

FIG. 17 is a view illustrating an implementation example of a semiconductor package.

Referring to FIG. 17, the semiconductor package 2000 may include a plurality of stacked memory devices 2100 and a system-on-chip 2200. The stacked memory devices 2100 and the system-on-chip 2200 may be stacked on the interposer 2300, and the interposer 2300 may be stacked on a package substrate 2400. The semiconductor package 2000 may transmit and receive signals to and from other external packages or semiconductor devices through solder balls 2001 attached to a lower portion of the package substrate 2400.

Each of the stacked memory devices 2100 may be implemented based on the HBM standard, but the present disclosure is not limited thereto. Each of the stacked memory devices 2100 may be implemented based on the GDDR, HMC, or Wide I/O standard. Each of the stacked memory devices 2100 may correspond to the stacked memory device 1100 of FIG. 16.

The system-on-chip 2200 may include at least one processor such as a CPU, an AP, a GPU and an NPU, and a plurality of memory controllers for controlling the plurality of stacked memory devices 2100. The system-on-chip 2200 may transmit and receive signals to and from a corresponding stacked memory device through the memory controller. The system-on-chip 2200 may correspond to the system-on-chip 1200 of FIG. 16.

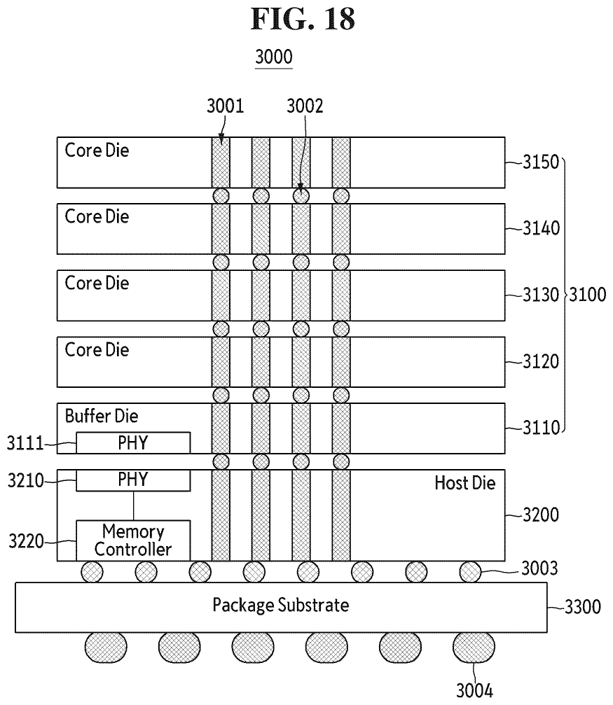

FIG. 18 is a view illustrating a semiconductor package.

Referring to FIG. 18, the semiconductor package 3000 may include a stacked memory device 3100, a host die 3200, and a package substrate 3300. The stacked memory device 3100 may include a buffer die 3110 and core dies 3120 to 3150. The buffer die 3110 may include a physical layer 3111 for performing communication with the host die 3200, and each of the core dies 3120 to 3150 may include a memory cell array.

The host die 3200 may include a physical layer 3210 for performing communication with the stacked memory device 3100, and a memory controller 3220 for controlling the overall operation of the stacked memory device 3100. The host die 3200 may also include a processor for controlling the overall operation of the semiconductor package 3000 and executing an application supported by the semiconductor package 3000. For example, the host die 3200 may include at least one processor such as a CPU, an AP, a GPU and an NPU.

The stacked memory device 3100 may be disposed on the host die 3200 based on TSVs 3001 and vertically stacked on the host die 3200. Therefore, the buffer die 3110, the core dies 3120 to 3150 and the host die 3200 may be electrically connected to one another through the TSVs 3001 and bumps 3002 without an interposer. For example, the bumps 3002 may be micro-bumps.

Bumps 3003 may be attached to an upper portion of the package substrate 3300, and solder balls 3004 may be attached to a lower portion of the package substrate 3300. For example, the bumps 3003 may be flip-chip bumps. The host die 3200 may be stacked on the package substrate 3300 through the bumps 3003. The semiconductor package 3000 may transmit and receive signals to and from other external packages or semiconductor devices through the solder balls 3004.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure.

Therefore, it should be appreciated that the embodiments as described above is not restrictive but illustrative in all respects.

What is claimed is:

1. A volatile memory device comprising:
a memory cell array including a first space and a second space; and
a control logic circuit configured to control an operation of the memory cell array, wherein the control logic circuit is configured to:
in response to receiving a first read control command targeting model data stored in the first space, read the model data, from first model data stored at a first start address in the first space to second model data stored at a first end address in the first space, in sequential order by address, and
in response to receiving a second read control command targeting second data stored in the second space, read the second data in non-sequential order by address from the second space.

2. The volatile memory device of claim 1, wherein the control logic circuit is further configured to:
receive a first data clock signal having a first frequency and a second data clock signal having a second frequency lower than the first frequency,
in response to receiving the first read control command, read the model data from the first model data to the second model data based on the first data clock signal, and
in response to receiving the second read control command, read the second data based on the second data clock signal.

3. The volatile memory device of claim 2, wherein the volatile memory device further includes a voltage generator configured to generate a voltage sufficient to read data,
wherein the voltage generator is configured to, in response to receiving the first read control command, generate a first read voltage having a first magnitude to perform a read operation based on the first data clock signal, and
in response to receiving the second read control command, generate a second read voltage having a second magnitude lower than the first magnitude to perform a read operation based on the second data clock signal.

4. The volatile memory device of claim 1, wherein the control logic circuit is configured to, in response to receiving a space allocation control command instructing the control logic circuit to allocate a space for storing model data, allocate a third space in the memory cell array.

5. The volatile memory device of claim 1, wherein the memory cell array further includes a third space, and
the control logic circuit is configured to, in response to receiving a first write control command instructing the control logic circuit to write third model data to fourth model data in the third space, write the third model data to the fourth model data in sequentially-ordered addresses in the third space.

6. The volatile memory device of claim 5, wherein the control logic circuit is configured to, in response to receiving a third read control command targeting the third space, read, from fifth model data stored at a second start address in the third space to sixth model data stored at a second end address in the third space, in sequential order by address.

7. The volatile memory device of claim 1, wherein the first read control command includes the first start address and the first end address.

8. The volatile memory device of claim 1, wherein the first start address is a first address of the first space, and
the first end address is a last address of the first space.

9. The volatile memory device of claim 1, wherein the control logic circuit includes a mode register configured to store information indicating an operation mode of the volatile memory device, and
the mode register is configured to provide a memory controller with information indicating whether the volatile memory device is configured to read data in sequential order by address and in non-sequential order by address in response to respective read control commands.

10. A memory controller comprising:
a processing circuit configured to control an operation of a volatile memory device, the volatile memory device including a first space allocated to storing a first model data set and a second space allocated to storing second data; and
a clock generator configured to provide, to the volatile memory device, a clock signal for the operation of the volatile memory device,
wherein the clock generator is configured to generate a first data clock signal having a first frequency and a second data clock signal having a second frequency lower than the first frequency,
wherein the processing circuit is configured to, in response to receiving a first read command targeting the first model data set, provide the volatile memory device with:
a first read control command instructing the volatile memory device to read the first model data set in sequential order by address,
the first data clock signal,
a first start address that is a first address of the first model data set, and
a first end address that is a last address of the first model data set, and
wherein the processing circuit is configured to, in response to receiving a second read command targeting the second data, provide the volatile memory device with:
a second read control command instructing the volatile memory device to read the second data in non-sequential order by address,
the second data clock signal, and
an address of the second data.

11. The memory controller of claim 10, wherein the processing circuit is further configured to provide the volatile memory device with a space allocation control command instructing the volatile memory device to allocate a space for storing a second model data set.

12. The memory controller of claim 10, wherein the volatile memory device further includes a third space allocated to storing a second model data set, and
the processing circuit is further configured to, in response to receiving a first write command instructing the memory controller to write the second model set, provide the volatile memory device with a first write control command instructing the volatile memory device to write the second model data set in the third space in sequentially-ordered addresses.

13. The memory controller of claim 12, wherein the processing circuit is configured to, in response to receiving a second read command instructing the memory controller to read the second model data set, provide the volatile memory device with:
a second read control command instructing the volatile memory device to sequentially read the second model data set in sequential order by address,
the first data clock signal,
a second start address that is a first address of the second model data set, and
a second end address that is a last address of the second model data set.

14. A memory system comprising:
a memory cell array including a first space and a second space;
a volatile memory device including a control logic circuit configured to control the memory cell array; and
a memory controller including a processing circuit configured to control an operation of the volatile memory device, and the memory controller further including a clock generator configured to provide the volatile memory device with a clock signal for the operation of the volatile memory device,
wherein the clock generator is configured to generate a first data clock signal having a first frequency and a second data clock signal having a second frequency lower than the first frequency,
wherein the control logic circuit is configured to, in response to receiving a first read control command targeting the first space, read at least some of a plurality of model data, stored in the first space, in sequential order by address based on the first data clock signal, and
wherein the control logic circuit is configured to, in response to receiving a second read control command targeting second data stored in the second space, read the second data stored in the second space in non-sequential order by address based on the second data clock signal.

15. The memory system of claim 14, wherein the control logic circuit is configured to, in response to receiving the first read control command targeting the first space, read, from first model data stored at a first start address in the first space to second model data stored at a first end address in the first space, in sequential order by address.

16. The memory system of claim 15, wherein the first read control command includes the first start address and the first end address.

17. The memory system of claim 15, wherein the first start address is a first address of the first space, and
the first end address is a last address of the first space.

18. The memory system of claim 14, wherein the volatile memory device further includes a voltage generator configured to generate a voltage sufficient to read data,
the voltage generator is configured to, in response to receiving the first read control command, generate a first voltage to perform a read operation based on the first data clock signal in response to receiving the first read control command, and
the voltage generator is configured to, in response to receiving the second read control command, generate a second voltage lower than the first voltage to perform a read operation in accordance with the second the second data clock signal.

19. The memory system of claim 14, wherein the control logic circuit is configured to in response to receiving, from the memory controller, a space allocation control command instructing volatile memory device to allocate a space for storing model data, allocate a third space in the memory cell array.

20. The memory system of claim 14, wherein the memory cell array further includes a third space, and
the control logic circuit is configured to, in response to receiving, from the memory controller, a first write control command instructing the volatile memory device to write third model data to fourth model data in the third space, write the third model data to the fourth model data in sequentially-ordered addresses in the third space.
